(19) United States
(12) Patent Application Publication
(10) Pub. No.: US 2006/0045672 A1
(43) Pub. Date: Mar. 2, 2006

(54) Rail carriage and rail carriage system

(76) Inventors: Michael D. Maynard, Paintsville, KY (US); Richard C. Young, Bonita Springs, FL (US); Ronald E. Ward, Paintsville, KY (US)

Correspondence Address: David W. Carrithers;CARRITHERS LAW OFFICE, PLLC, One Paragon Centre, Suite 140, 6060 Dutchman's Lane, Louisville, KY, 40205, US

(21) Appl. No.: 11/095,030

(22) Filed: Mar. 31, 2005

Related U.S. Application Data
(63) Continuation-in-part of application No. 10/895,031, filed on Jul. 20, 2004.
Application No. 10/895,031 is a continuation-in-part of application No. 09/902,477, filed on Jul. 10, 2001, now Pat. No. 6,764,266.
Application No. 09/902,477 is a continuation-in-part of application No. 09/363,622, filed on Jul. 29, 1999, now Pat. No. 6,257,821.
Application No. 09/363,622 is a continuation-in-part of application No. 08/898,073, filed on Jul. 22, 1997, now Pat. No. 6,234,737.

(51) Int. Cl. B65G 1/00

(52) U.S. Cl. 414/276

(57) ABSTRACT

A track and carriage system that includes a pair of spaced apart parallel rails and a carriage rollingly mounted on the rails. The carriage is a rectangular, in plan view, structural unit having a pair of opposite parallel marginal edges with a frame side rail secured to each of the marginal edges. Rollers journalled on the side rails rollingly support the carriage on the rails. A motor mounting subassembly carried by the carriage provides a downwardly facing channel that receives therein a portion of one of the rails. A plurality of rollers on the motor mounting subassembly maintains a minium air gap between a linear motor mounted on the subassembly and a magnetic strip on an adjacently disposed side face of one of the rails. The carriage structural portion maybe a plurality of beams disposed side-by-side or one or more extruded monolithic cast structures. A structural plate like member maybe mounted on the load carrying frame. If desired a power driven roller conveyor maybe mounted on the carriage for loading and off loading goods. Also the motor mounting subassembly and a frame side rail secured thereto running on a single rail provides a mono rail transfer vehicle.

### RELATED APPLICATIONS

This application and claims priority from Provisional application Ser. No. 60/558,356 filed on Mar. 31, 2004 and is a Continuation-In-Part of Ser. No. 10/895,031 filed on Jul. 20, 2004, which is a Continuation-In-Part of U.S. Pat. No. 6,764,266 which issued on Jul. 20, 2004 from application Ser. No. 09/902,477 filed on Jul. 10, 2001, which is a Continuation-In-Part of U.S. Pat. No. 6,257,821 which issued on Jul. 10, 2001 from application Ser. No. 09/363,622 filed on Jul. 29, 1999, which is a Continuation-In-Part of U.S. Pat. No. 6,234,737 which issued on May 22, 2001 from application Ser. No. 08/898,073 filed on Jul. 22, 1997, all of which are hereby incorporated by reference.

### TECHNICAL FIELD OF THE INVENTION

This invention relates generally to remotely controllable article handling system and more particularly to a carriage and track system and rail carriages for use on a track or track system wherein the carriage is propelled along the track by a linear motor system in which the linear motor is mounted on the carriage and coacts with a strip of magnets on a side face of at least one rail.

### BACKGROUND OF THE INVENTION

Moreover, conventionally an order for goods is received by a supplier of the same and the goods for that order are picked by hand from a warehouse containing the goods and those hand picked items are packaged and sent out to the party that had requested the same.

By way of example a store may order cases of various different soft drinks for resale in their store. At the warehouse there are cases stacked one on top another and in side by side relation of one specific soft drink and in another stack, or stacks, another variety and so on dependent on the number of different varieties carried by that warehouse. When an order is received at the warehouse one or more individuals set about hand picking the cases of goods to fill the order and take them to a dispatch area. The task is labor intensive, expensive and time consuming.

There is disclosed in U.S. Pat. Nos.: 6,257,821, 6,764,266, and 6,234,737 entitled “Robotic Container Handler Systems” a rail and carriage system utilizing linear magnetic motors to controllably propel a carriage along a track consisting of a pair of parallel spaced apart rails.

The present invention is directed to improvements in the construction of the carriage, and to the rails and to a rail and carriage portion of an article handling system intended primarily for improving warehousing of goods by mechanizing handling of the goods being warehoused and/or removed from the warehouse at high speeds and extreme accuracy.

The present invention is efficient in sorting, stacking, and conveying goods in an automated high speed system capable of sorting and moving articles in a few seconds. The present invention eliminates the necessary of persons to work in close proximity to the high speed operating equipment thereby eliminating the hazards associated therewith and the strenuous physical activities associated with sorting and moving the articles and/or containers from the sorting apparatus to the distribution point.

### SUMMARY OF THE INVENTION

An object is to provide a carriage for the intended purpose which is simple end easily manufactured.

A further object of the present invention is to provide at least one rail which holds the carriage wheels captive and thereby reduce the likelihood of the carriage tipping or being derailed when subjected to tipping forces for example by over reaching and/or overloading a loading crane mounted on the carriage.

A further object is to provide an improved load hauling carriage and rail system.

It is an object of the present invention to provide a carrier to interface with an article, a container, a tray, a pallet, or a layer that includes onboard lock-up means that retains the payload as the carrier is used for transportation.

It is an object of the present invention to provide a means for loading an article or payload containing goods, transport it to a position determined by an overall system controlling computer and unload the tray containing goods at a selected location at a selected time.

It is an object of the present invention to provide a carrier platform for supporting a robot, wherein said carrier platform base I powered by linear servo magnetic motors providing a very high acceleration and deceleration and the ability to park the entire system consistently within 0.010 inches of a preselected position.

It is an object of the present invention to provide a robot powered by a linear magnetic motor which is cooperatively magnetically engageable with a master rail having a plurality of permanent magnets affixed thereto together with nonferrous guide rollers which maintain a necessary selected gap of about 0.020 of an inch between the motor and rail magnets in order to drive the unit back and forth in the X-axis with high speed and precision.

It is an object of the present invention for the linear motor and magnetic rail system to be adaptable with the carrier platform for moving same over flat surfaces such as a floor with the aid of a second minor rail or balancing rail and for the entire track and carrier platform to be suspended above the ground.

A further object is to provide an improved load hauling carriage and rail system which can be mounted on a floor, overhead, vertically, horizontally, and can move along a straight or curved track at high speeds and stop with extreme accuracy.

An object of the present invention is to mechanize the above described hand operation of retrieving one or more cases of a goods from a storage area containing a quantity of such goods.

A further object of the present invention is to provide a specific apparatus for picking up an article from a quantity of the same and moving it to a selected location for further handling.

A moving platform comprises a carriage that is rollingly supported by a plurality of rollers on the rails together with an upper plate that is rectangular in plan view and of selected dimensions suitable for the task at hand. A package transfer apparatus such as a plurality of side-by-side parallel rollers can be mounted on the carriage and disposed above the plate for loading and unloading articles onto and off the carriage. The rollers are power driven and reversible so as to move goods thereon in one direction or the other.

A rigid support structure is carried by the platform. A reach unit is movably mounted for movement up and down on the rigid structure by a reach unit mounting structure. The reach unit includes power means to extend the same a selected distance beyond at least one side (preferably both sides) of the support structure and a further power means raises and lowers the reach unit mounting structure on the rigid support structure.

A pair of telescopic members can be slidably mounted on the reach unit to extend beyond one side or the other of opposite sides of the rigid support structure wherein it is extendable a selected amount beyond each of the opposite sides of the support structure.

In keeping with the foregoing objects there is provided in accordance with the present invention a system for automatically retrieving at least one article from a preselected area containing a quantity of such articles and delivering the same to a preselected designated area spaced from the storage area, the system comprising:

(A) a storage area holding a selected quantity of the articles from which at least one is to be retrieved, the articles being stacked one upon another in at least one stack and being accessible from one side of the storage area;

(B) a track extending a selected distance along a predetermined path that is spaced a selected distance from the one side; and

(C) a carriage carried by the track and being movable there along back and forth in a horizontal direction designated x-x, the carriage having a load carrying support surface thereon and power means to propel the carriage along the track;

(D) a power operated article gripping assembly carried by the reach assembly for grasping an article to be retrieve from the storage area; and

(E) Programmable Logic Controller means inter-relating and controlling movement of the carriage along the track, extension and retraction and up and down movement of the reach unit, and operation of the article gripping assembly to retrieve at least one article from the storage area and deliver the same to a preselected receiving area.

In accordance with one aspect of the present invention there is provided a linear motor rail transfer vehicle comprising a rigid elongate rail having a mounting flange, a web and a further flange together providing a rail having respective first and second opposite side faces the flanges and web defining an open faced channel along the first side face of the rail. An elongate magnet mounting strip of material secured to the rail and extends along the second side face. A carriage comprising a motor mounting subassembly is movably mounted on the rail. The motor mounting subassembly includes an elongate rigid beam having a open faced channel receiving therein a portion of the rail that projects from the surface of a support structure on which the rail is mounted. A first plurality of spaced apart rollers is journalled on the rigid beam. The first plurality of rollers are disposed in the open faced channel in the first side face of the rail. A second plurality of spaced apart rollers are journalled on the carriage and roll reacting against the second side face of the rail. A third plurality of rollers are journalled on the carriage and rollingly react against the first side of the rail. The rollers rollingly supporting the carriage on the rail and guide the same there along. Magnets are secured to the magnet mounting strip and extend in a strip therealong at selected internals at the second side of the rail. At least one linear motor is mounted on the beam and disposed in the channel therein in face-to-face relation with the magnets on the magnet mounting strip. The second plurality of rollers define a selected minium air gap between the strip of magnets on the rail and an adjacently disposed face of the motor.

In accordance with a further aspect of the present invention, there is provided a rail carriage rollingly mountable on a track comprising a pair of laterally spaced apart parallel rails. The carriage comprises a load carrying structural frame having rollers journalled thereon that rollingly engage and thereby support the carriage on the pair of rails. The frame has a pair of oppositely disposed marginal edges, and a longitudinally extending motor mounting subassembly is carried by the structural frame providing a downwardly facing channel disposed to receive therein a portion of one of the pair of rails on which the carriage is rollingly supported. A linear motor is mounted on the subassembly and located in the downwardly facing channel at a position in face-to face relation with a side face of a rail on which there is mounted thereon a strip of magnets.

There is also provided in accordance with the present invention a track and carriage system comprising a pair of laterally spaced apart parallel rails and a carriage rollingly mounted on the rails. The carriage comprises a load carrying structural frame having rollers journalled thereon rollingly engaging and thereby supporting the carriage on the pair of rails. The structural frame has a pair of oppositely disposed marginal edges, and a longitudinally extending motor mounting subassembly on the structural frame and providing a downwardly facing channel receiving therein a portion of one of the pair of rails. A linear motor is mounted on the subassembly and located in the downwardly facing channel at a position in face-to face relation with a side face of the rail. A strip of magnets is mounted to the rail side face and means are included to maintain a selected air gap between the linear motor and the strip of magnets.

The load carrying structural frame maybe a plurality of elongate beams disposed side-by-side and interconnected to provide a rigid assembly or a cast member or at least one and preferably a plurality of interconnected cast members. The support rollers can be journalled on the load carrying structural frame but preferably are located on respective ones of a pair of side rails located on respective ones of the oppositely disposed longitudinal marginal edges of the rigid frame.

Moreover, the present invention also defines a robotic parts handling system having a carrier forming a platform base including at least one linear servo magnetic motor affixed to and extending along the side beneath the platform. The platform is supported by a track including a first master rail including magnets affixed thereto. One or more minor balancing rails may be incorporated therewith for additional support of the carrier platform. A plurality of supporting rollers supporting and hold the platform to the first master rail and the second minor balancing rail. A plurality of magnets mounted along the length of the first master rail are in cooperative magnetic engagement with the at least one linear servo magnetic motor. A plurality of positioning rollers mounted to the platform maintain a constant distance between the linear servo magnetic motor and the magnets mounted to the first master rail. A computer control unit controls and coordinates movement of the carrier platform along the rails and the operation of the robotic end effector means for picking and gripping objects. A magnetic strip provides a means in close proximity to the rail for generating pulses readable by a reader in communication with the control unit for positioning the platform at selected positions upon the rail.

The present invention defines a high speed robotic container handling system having a digital magnetic positioning system, a platform frame having a linear servo motor thereon moveable along at least one rail which includes magnets affixed thereto.

In one embodiment the rail vehicle comprises only one frame side rail and the motor mount subassembly and wherein they are interconnected to provide a rigid unit that is rollingly mounted on a single rail.

Of course, other means for positioning the carrier in relationship to the rail such as an optical encoder or inferometer can be used instead of or in addition to the magnetic encoder.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is an oblique view of a rail carriage constructed in accordance with one aspect of the present invention for use in transporting goods in warehousing the same.

FIG. 2 is an oblique view of the rail and carriage of the present invention in which the carriage of FIG. 1 is rollingly mounted on a pair of rails:

FIG. 3 is an end, part sectional, view of a carriage and rail system of FIG. 2;

FIG. 4 is similar to FIG. 3, but from the opposite end, and includes an on/off loading powered conveyor on the carriage;

FIG. 5 is a right hand side elevational view of the FIG. 4;

FIG. 6 is an oblique view of multiple carriages in end-to-end relation on a pair of rails;

FIG. 7 is an oblique view of two carriages joined together in end-to-end relation on a pair of rails and each having a power driven roller on/off loading conveyor thereon;

FIG. 8 diagrammatically illustrates a warehousing rail and carriage system of the present invention;

FIG. 9 is a side view of a portion of one track with a magnetic strip thereon of a linear magnetic motor;

FIG. 10 is top side oblique view of a modified rail carriage unit provided in accordance with a further aspect of the present invention;

FIG. 11 is a bottom side oblique view of the carriage illustrated in FIG. 10;

FIG. 12 is a sectional view taken along line 12-12 of FIG. 10;

FIG. 13 is an exploded oblique view of the magnetic motor mounting subassembly that is detachably mounted on the carriage and disposed along one marginal edge of the carriage shown in FIG. 10;

FIG. 14 is an exploded oblique view of the carriage shown in FIG. 10′

FIG. 15 is an oblique view of a pair of rails for the carriage;

FIG. 16 is an oblique exploded view of the encircled left end portion of the rails shown in FIG. 15 but on a larger scale’

FIG. 17 is similar to FIG. 16 but showing the opposite end portion of the pair of rails shown in FIG. 15;

FIG. 18 is an oblique view of a further rail system with a further modified rail carriage rollingly mounted thereon;

FIG. 19 is a plan view of a further rail system with a further modified rail carriage rollingly mounted thereon;

FIG. 20 is a side view of a further rail system with a further modified rail carriage rollingly mounted thereon;

FIG. 21 is a top plan view of the carriage frame portion or the carriage illustrated in FIGS. 18, 19 and 20;

FIG. 22 is a side elevational view of FIG. 21;

FIG. 23 is a left hand end elevational view of FIG. 22;

FIG. 24 is a top plan view of a linear transfer vehicle that includes a magnetic motor mounting assembly rollingly mounted on a single rail;

FIG. 25 is a side elevational view of FIG. 24;

FIG. 26 is an oblique view of the mono rail system shown in FIGS. 24 and 25;

FIG. 27 is and enlarged view of the encircled portion on FIG. 26;

FIG. 28 is a sectional view taken along line 28-28 of FIG. 25;

FIG. 29 is a side view of a brake assembly;

FIG. 30 is a oblique view of the brake assembly mounted on the carrier or linear transfer vehicle; and

FIG. 31 is a top view of the brake assembly mounted on the carrier or linear transfer vehicle.

### DETAILED DESCRIPTION OF THE PREFERRED EMBODIMENT

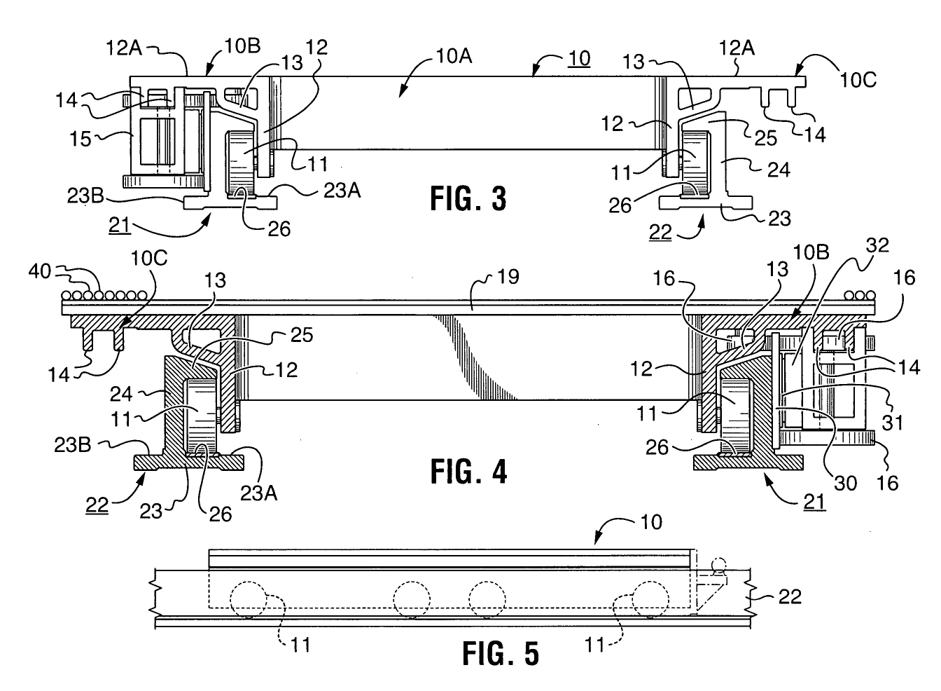

Illustrated in FIGS. 2 and 3 is a rail carriage 10 rolling mounted on a rail system 20 comprising a spaced apart pair of rails 21, 22.

The rails 21, 22 of one preferred embodiment are aluminum extrusions that have a bottom flange 23, an upwardly projecting web 24 and a top laterally directed flange 25. Of course the rails can be composed of any nonmagnetic material having sufficient structural strength and rigidity. The flanges 23, 25 and the web therebetween define a channel receiving therein a first plurality of rollers 11 journalled on the carriage. Flange 23 has portions 23A, 23B respectively on opposite sides of the web and these rollers run on a strip 26 of wear resistant material, for example steel, secured to the rail flange portion 23A.

The carriage 10 comprises a central load support member 10A and elongate members 10B, 10C detachably secured thereto along respective opposite parallel sides thereof.

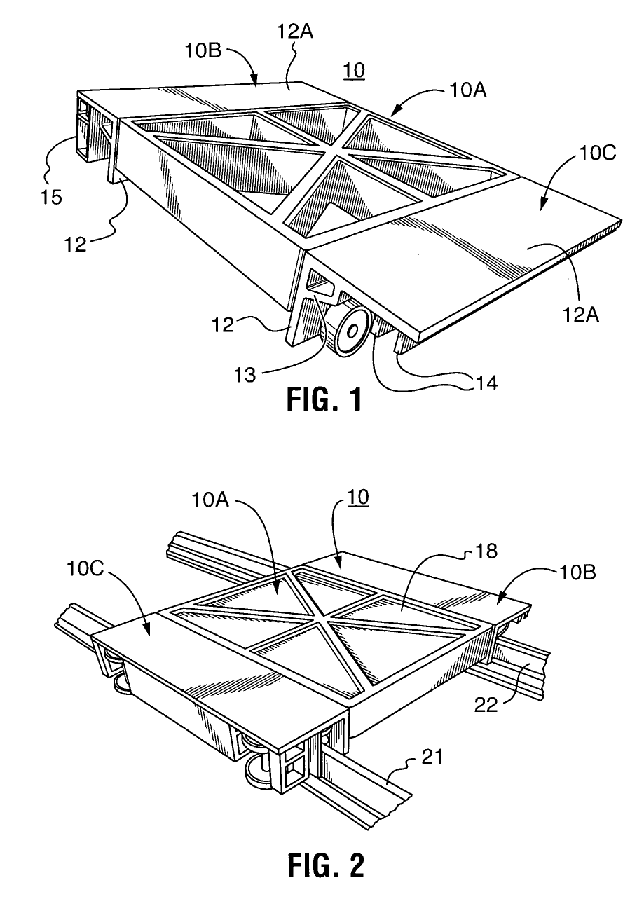

The central support member has an outer peripheral frame and an open central portion provided by diagonal and transverse braces clearly illustrated in FIG. 1. The member 10A maybe a short length of an extruded member or a casting which in either event is preferably a monolithic structure.

The members 10B, 10C each comprise a length portion of an extrusion having flanges 12, and 12A disposed at right angles to one another and reinforced by a gusset portion 13. Flange 12A has a spaced apart pair of parallel ribs 14 (or equivalent formation) projecting downwardly therefrom. The other flange 12 is directed downwardly and is secured in any suitable manner, for example bolt and nut assemblies, to the outer peripheral wall of the central member 10A. This construction allows inserting spacers to vary the spacing of rollers on opposite sides to suit the spacing of the rails 21, 22.

The plurality of free wheeling rubber rollers hold the carrier platform to the rails as shown in the figures. The free wheeling rubber rollers can be constructed of other materials, either metallic or non-metallic, including but not limited to urethane, plastic, polymer, graphite, composite, steel, aluminum, or other such metal and/or any such combination of materials.

Member 10B has an elongate box like beam 15 secured to the ribs 14 and is spaced from the flange 12 providing there between a channel receiving therein the web 24 and the flange 25 of the rail 21.

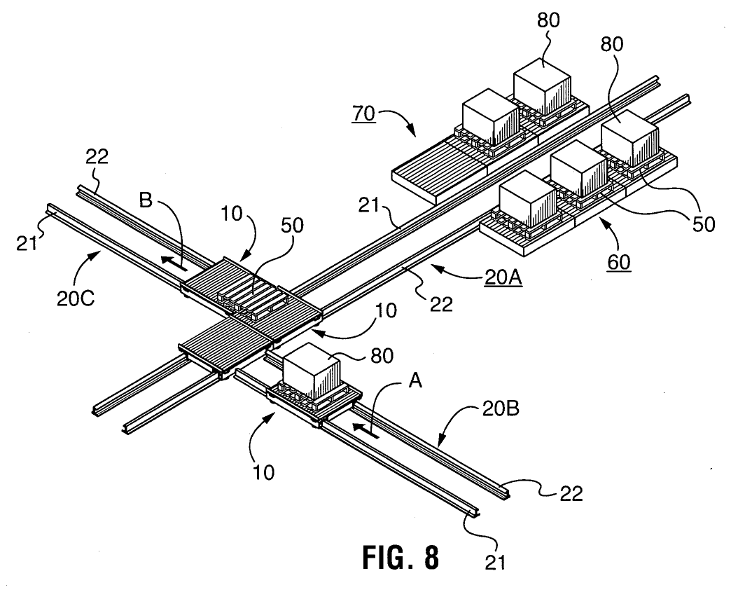

The rail or rails, in a warehouse installation, are securely fastened to the floor and follow a path offset a selected distance along one side of a storage area in the warehouse or between two such spaced apart storage areas 60, 70 diagrammatically illustrated in FIG. 8 to which the goods are to be delivered to or retrieved from as the case maybe.

In applicants aforementioned patents, the substance of which is incorporated herein by reference thereto, there is disclosed a superstructure carried by the carriage and a reach unit mounted thereon for retrieving goods from storage and placing the same on the carriage for transport to a loading zone. The present application is directed to the construction of the carriage, to the construction of the rails and to the rail and carriage combination and system and to a rail and carriage warehouse article handling system. The channels in the side of the rails face one another hold the carriage rollers 11 captive preventing tipping of the carriage during overreaching and/or lifting of heavy loads by an article reach and grip assembly mounted on the carriage superstructure more fully disclosed in the aforementioned application.

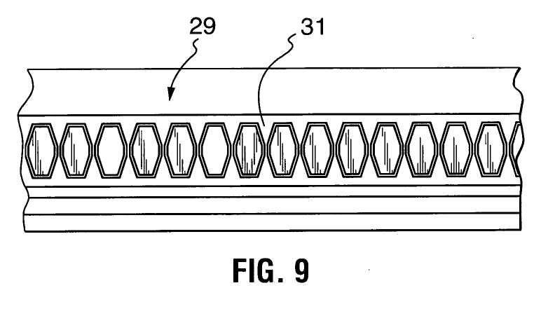

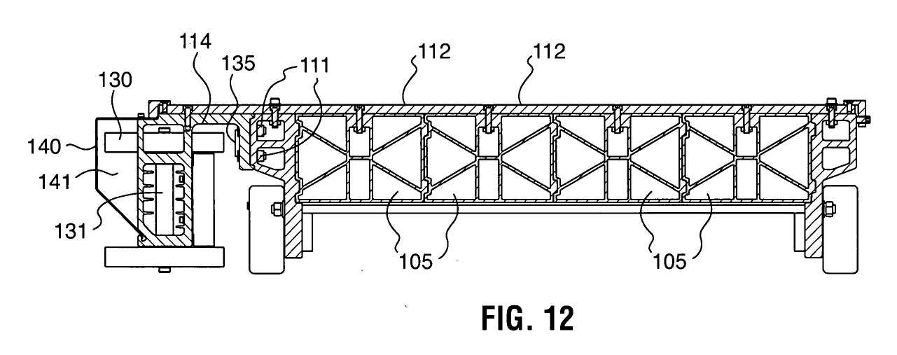

A strip 30 of steel plate (or equivalent), (such as is illustrated in FIG. 4), is secured to the web 24 of rail 21 and projects there above. A plurality of rollers 16, mounted by vertical spindles on the member 10B, rollingly engage respectively opposite vertical faces of the portion of the steel strip 30 projecting above the rail upper flange 25 and one exposed face of a lower portion of such strip. Magnets 31 are secured to an exposed side face of the strip 30 (see FIG. 9) and extend in a strip between paths of rolling engagement of the upper and lower sets of the rollers 16. A motor 32 is mounted on the box like beam 15 in face-to-face relation with a strip portion of the magnets and reacts with the same to propel the carriage along the track. The plurality of rollers 16 maintain a selected air gap of a few thousandths of and inch between the motor and the magnetic strip 31. The linear magnetic motor preferred by the applicant is approximately 30 inches long and therefore the carriage is preferably about 36 inches in length.

In situations where more capacity is required i.e. more power to propel a loaded carriage and/or more load space for the articles, two or more carriages are connected together one after another as diagrammatically illustrated in FIGS. 6, 7 and 8. The two or more carriages maybe separate units connected to one another by a ball type coupling shown in broken line in FIG. 5 or the extrusions of flanges 11, 12 etc maybe a continuous length, as diagrammatically illustrated in FIG. 6, spanning the two or more carriages as the case maybe.

As shown best In FIG. 2, the carriage is illustrated with a load supporting plate 18 covering only the central portion 10A of the carriage. In FIG. 4, there is illustrated a load carrying plate 19 spanning across sections 10A, 10B and 10C of the carriage.

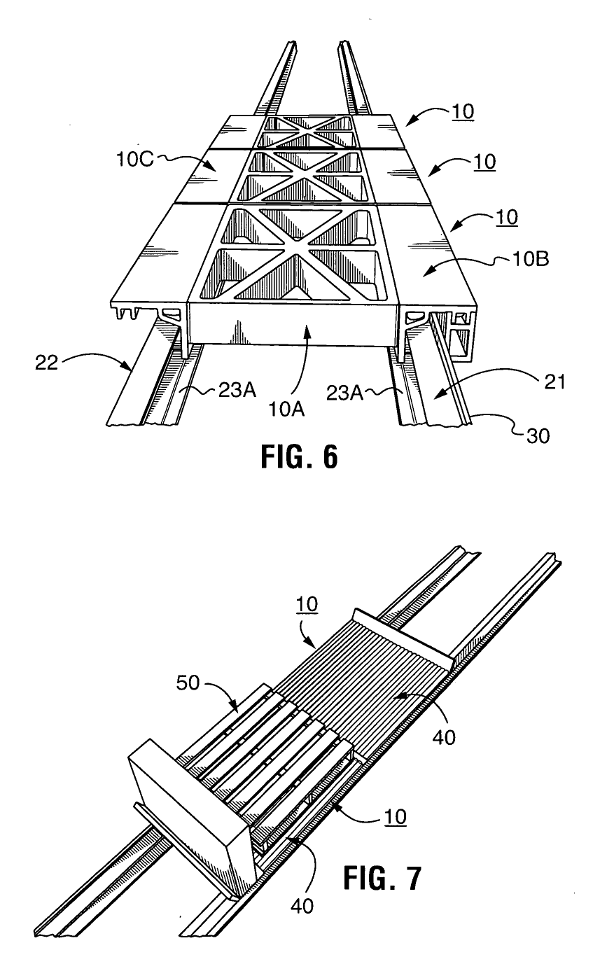

In FIGS. 4, 7 and 8 a power driven roller conveyor 40 is shown on the top of the carriage. Also illustrated in FIG. 7 is a conventional load pallet 50 on one of two carriages disposed end-to-end with it being understood that such pallet is located upon a roller driven conveyor illustrated by way of example in FIG. 4.

Referring to FIG. 8, there is illustrated a track system comprising a first rail track 20A that extends along a path, for example in a warehouse, between storage areas designated 60, 70 in which there is stored cartons of goods 80 on pallets 50. Respective second and third rail tracks 20B, 20C are disposed perpendicular to the first rail track and on respective opposite sides thereof. Each rail track 20A, 20B, 20C comprises at least one and as shown in a preferred embodiment, a pair of rails previously described as rails 21, 22. There is a carriage 10, with a power driven roller conveyor 40 thereon, on the respective tracks 20B, 20C that move goods toward and away from two carriages in tandem on the first rail track 10A. Warehouse incoming goods move in the direction of arrow A toward a carriage 10 on the first pair of rails and outgoing goods in the direction of arrow B. The first and second rail tracks 10B, 10C are offset from one another permitting simultaneously on/off loading the two carriages 10 on the rail track 10A.

The carriages disclosed in FIGS. 1 to 6 have a plurality of rollers 11 that roll on the rail flanges 23A and thereby rollingly support the carriage on the track which comprises a spaced apart pair of rails. A linear motor 32 is mounted on the elongate beam 15 and reacts with a strip of magnets on a side face of the rail 21 to propel the carriage along the track system. In the embodiment disclosed therein the rollers 11 are journalled on each of the respective elongate members 10B and 10C which in turn are detachably secured to respective opposite marginal edges of the central load support member 10A.

In embodiments to be described hereinafter the carriage supporting rollers are journalled on side frame rails that are secured to the carriage rigid structural frame. Such structural frame in one instance is a plurality of elongate beam members disposed side-by-side and suitably joined together to provide a rigid unit and in another instance it is a cast unit or units suitably secured together. In each embodiment there is an elongate motor mount subassembly that is detachably connected to the rigid structural frame and has a face portion disposed in selected spaced relation with a side face of one of the rails. A motor portion of a linear magnetic propulsion system is mounted on the motor mount subassembly and faces a strip of magnets mounted on the side face of the rail.

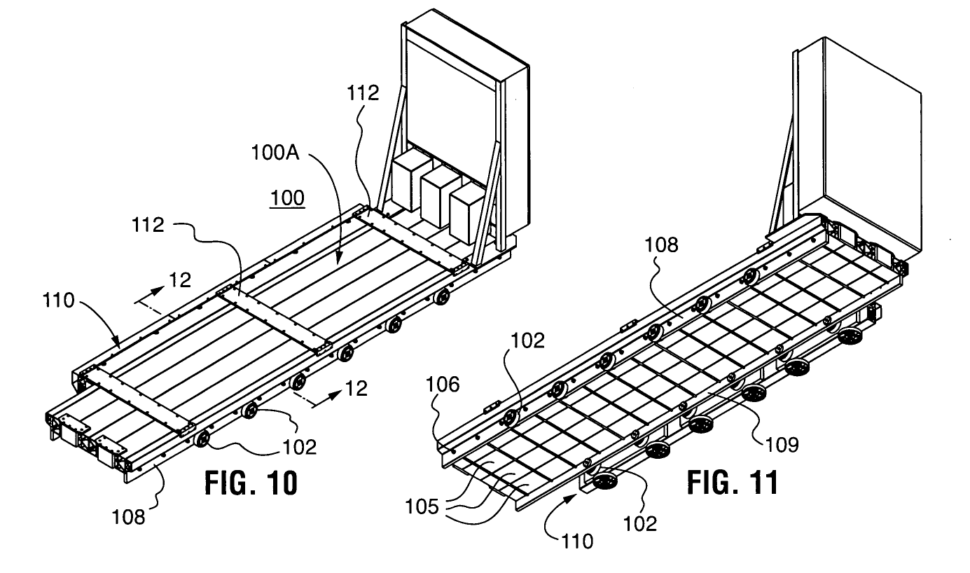

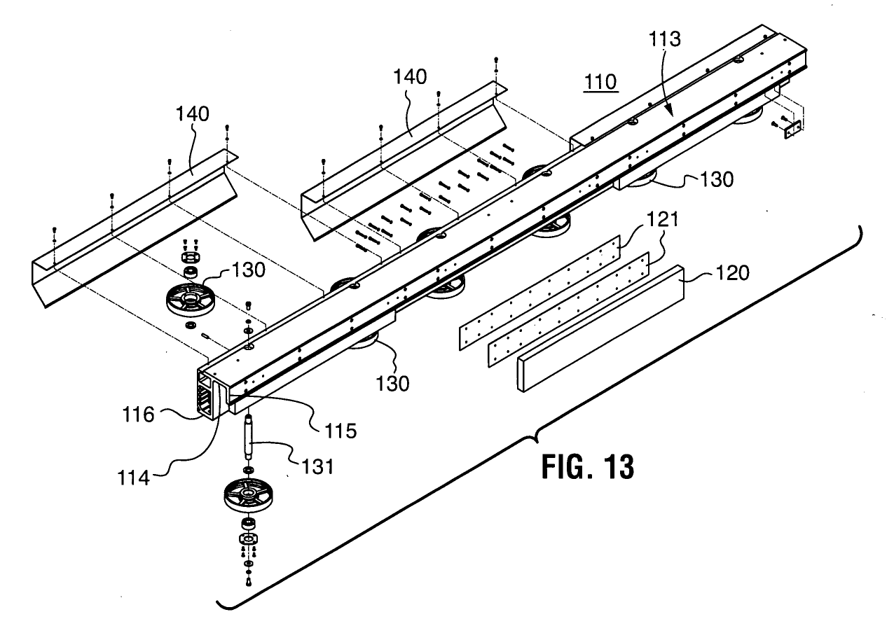

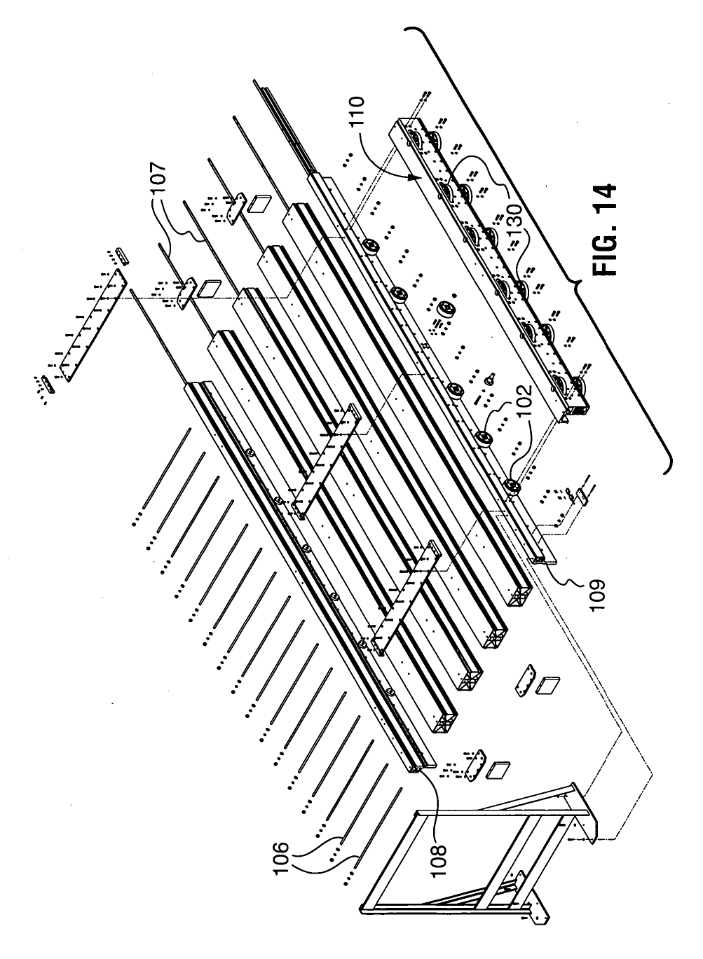

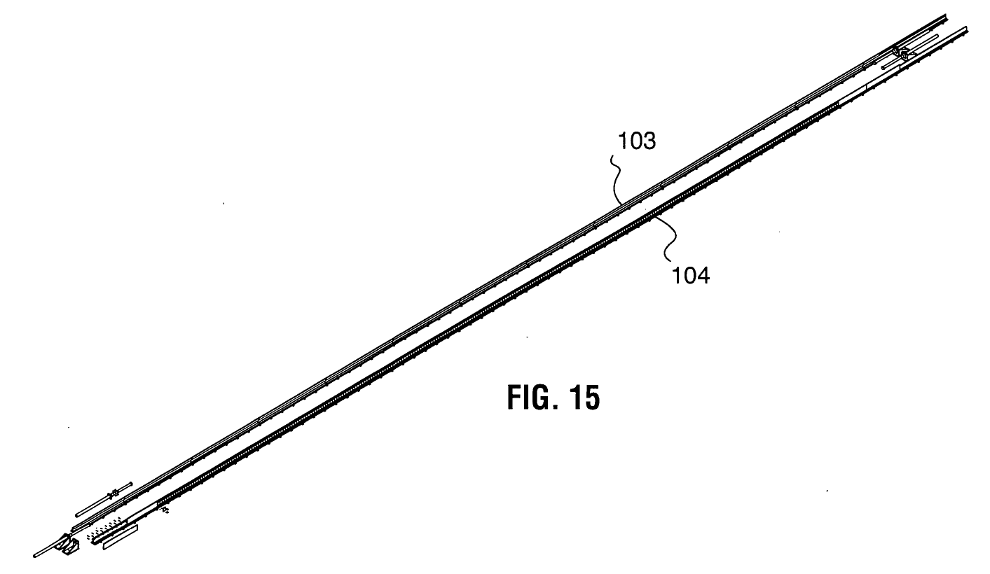

Referring to FIGS. 10 to 14, there is illustrated a rail carriage 100 with details of construction thereof being evident from FIGS. 12 and 14. The carriage 100 has a rigid structural unit 100A with a plurality of rollers 102 journalled thereon for rolling supporting the carriage on a track comprising a pair of laterally spaced parallel rails 103, 104 (see FIGS. 15-17). The rigid unit 100A includes a plurality of elongate support beams 105 disposed side-by-side and interconnected by rods 102 disposed transverse thereto and reinforced by rods 107 extending parallel to the beams. The support beams 101 are disposed between a pair of frame rails 108, 109 which have the load supporting rollers 102 journalled thereon.

An elongate motor mount subassembly 110 is detachably connected to the rigid frame 100A by a plurality of nut and bolt units 111 and a series of plates 112. It is powered by electricity from an electrical cable overhead, disposed along the track, or the electric power can be supplied via another rail in electrical communication with the motor(s). The subassembly 110 includes an elongate box beam 113 having a flange 114 projecting laterally therefrom which in turn has a downwardly projecting flange 115. The beam 113 has a side face 116 on which a linear motor 120 is mounted using shims 121 there between as maybe required. The flanges 114 and 115 space the beam side face 116 a selected distance from a side face 125 of the rail 104. A magnet mounting plate 121 is mounted on the rail side face 125 and has an upper edge portion 126 that projects above the rail. The linear motor 120 interacts with a strip 127 of magnets 128 on the magnetic mounting plate 121 to propel the carriage along the track.

The subassembly 110 has a plurality of rollers 130journalled thereon in pairs by respective ones of a plurality of axles 131 angularly disposed with respect to the axis of rotation of the load support rollers. The rollers 130 rollingly engage a side face of the rail 104, or plate 121 mounted thereon, so as to maintain a selected minium spacing between the motor 120 and the strip 127 of magnets 128. A wear strip 135 mounted on the flange 115 engages an opposite face of the plate projecting portion 126 and together with the rollers 130 guides the carriage along the track.

A cover 140 is detachably secured to the beam 113 and provides a channel 141 for power supply and wiring for the motor and motor control system.

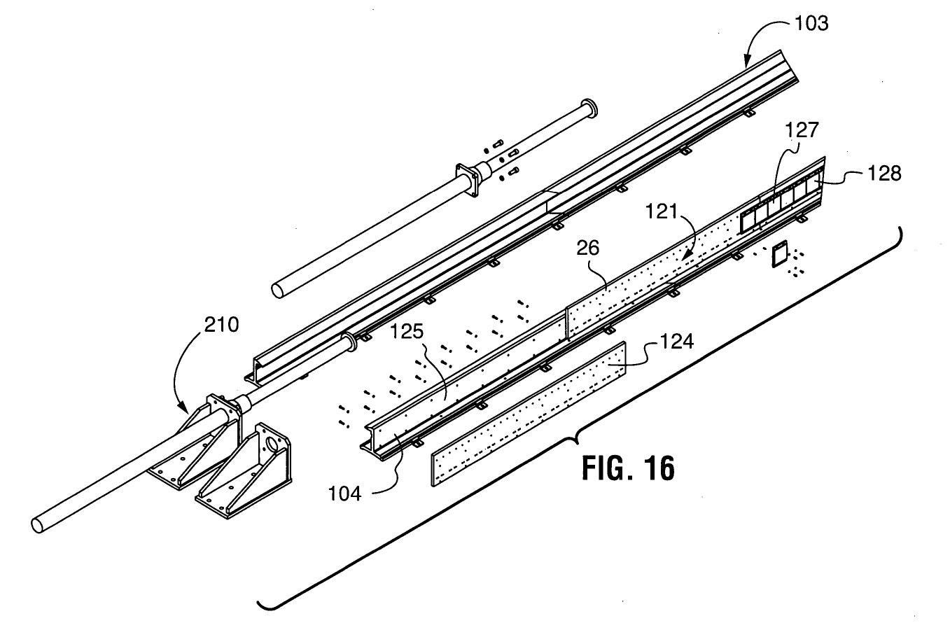

Shock absorbing carriage abutments 210, 211 are located adjacent respective opposite ends of the pair of rails 103, 104. Details of these are shown in respective FIGS. 16 and 17.

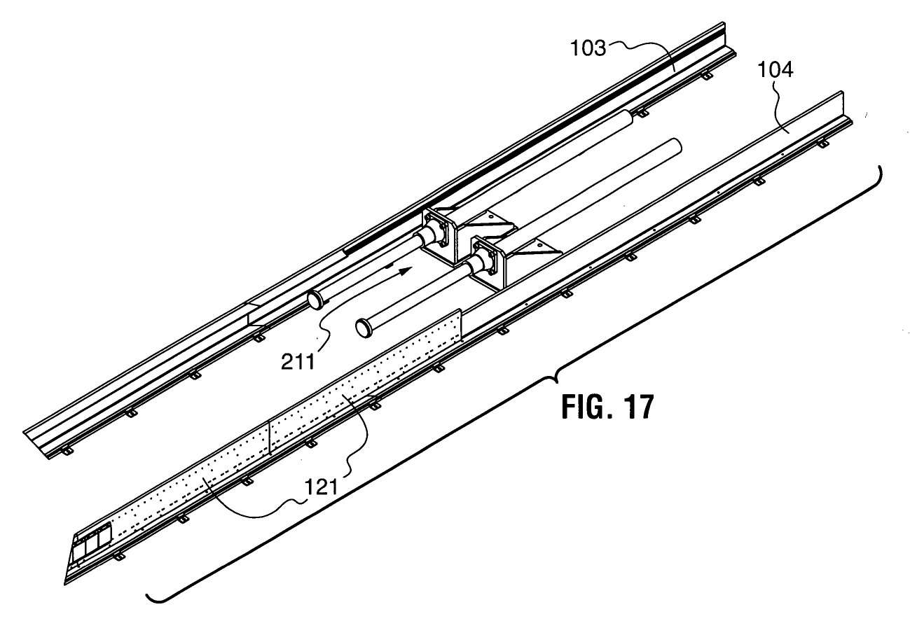

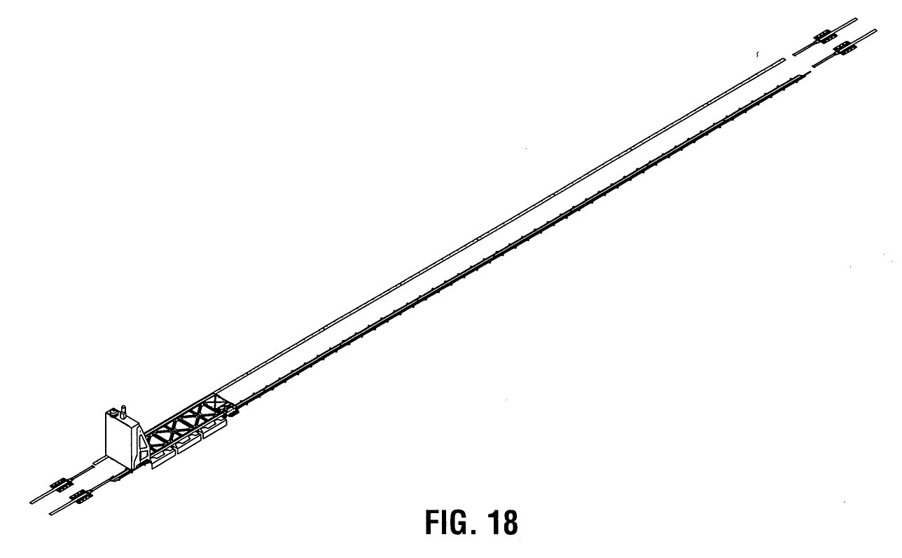

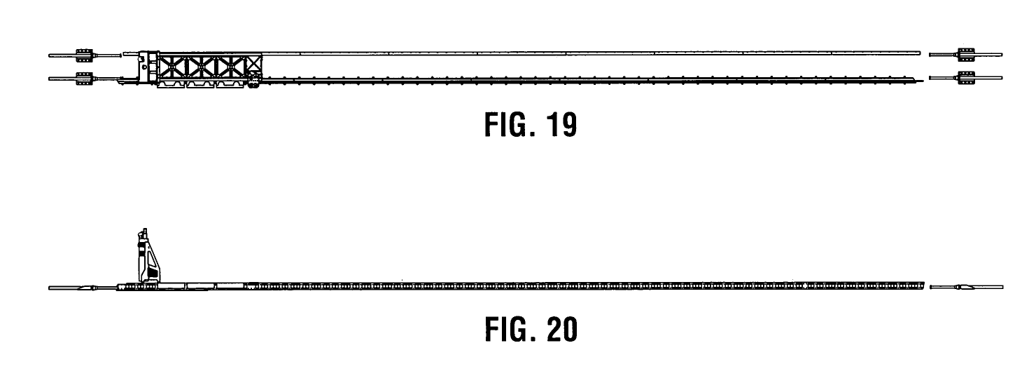

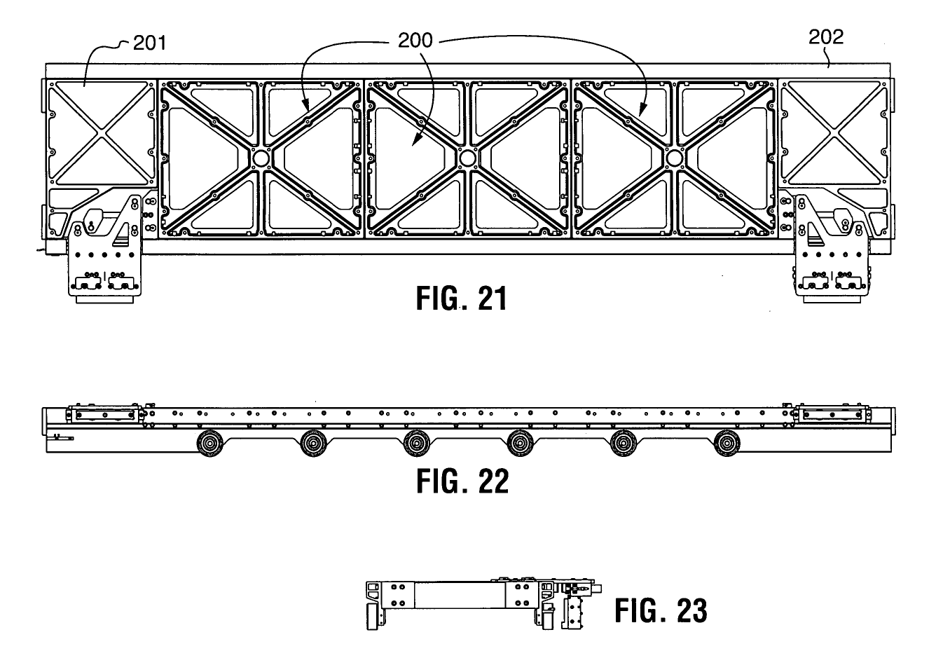

In the embodiment illustrated in FIGS. 18 to 23 the beams 105 of the carriage 100 are replaced by a cast frame units 200 suitably joined together and disposed between a pair of end units 201, 202.

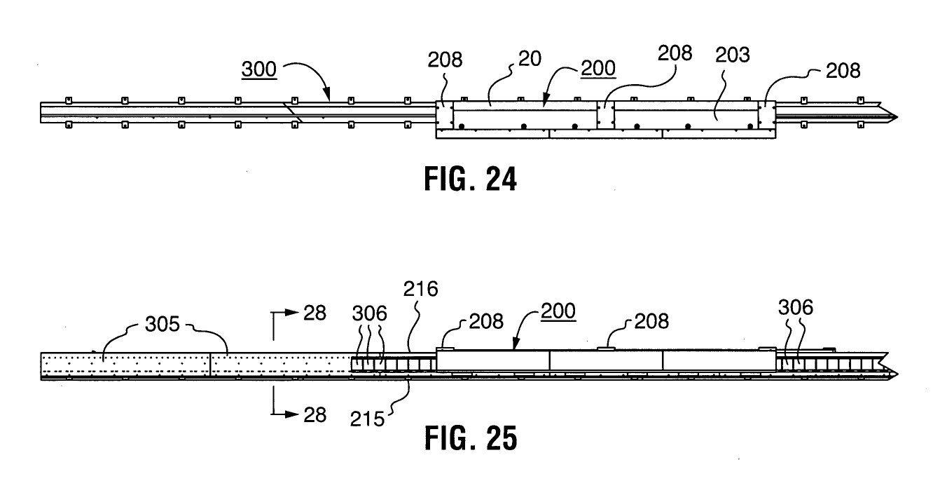

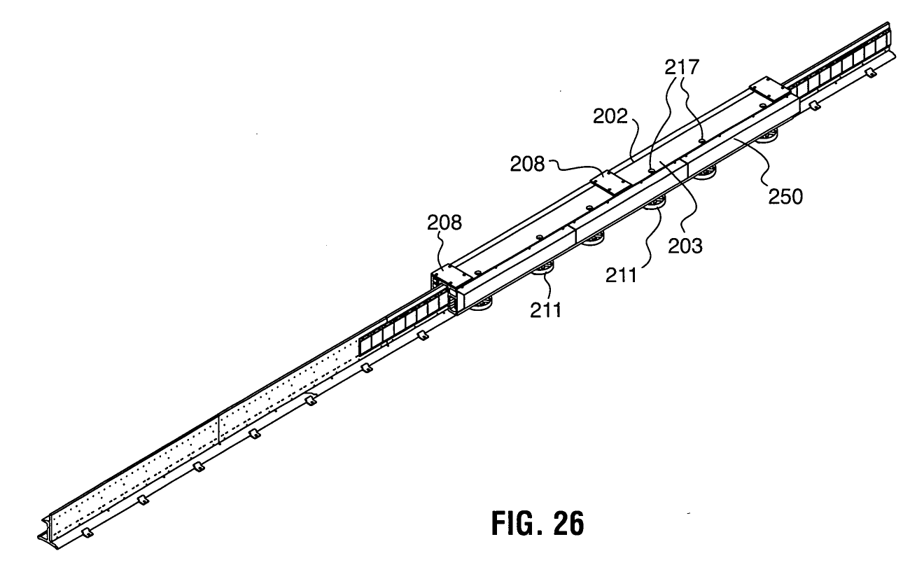

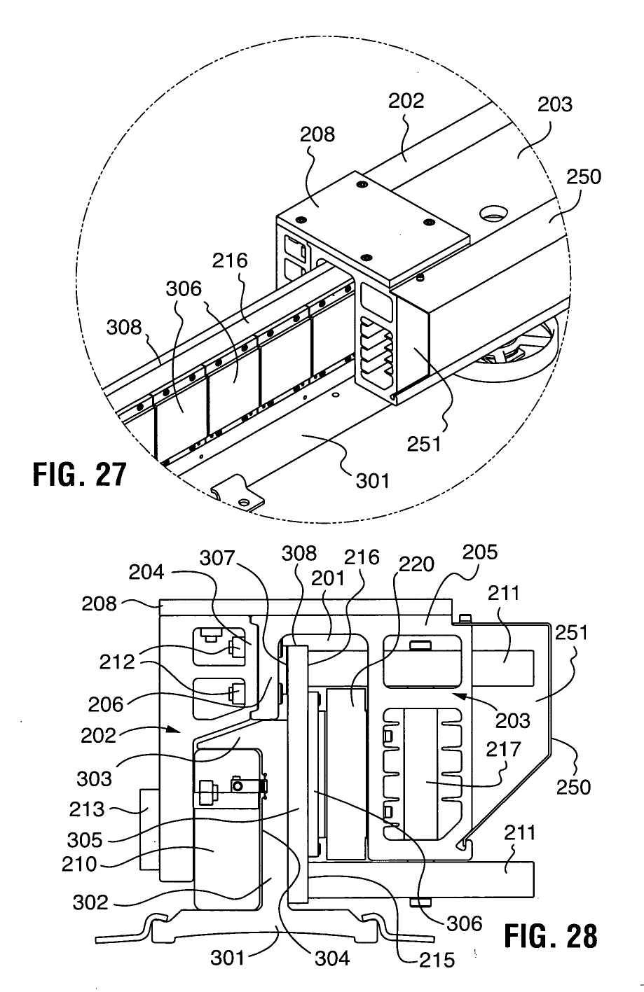

The motor mount subassembly and one frame side rail disclosed in the foregoing can be utilized without the forgoing described rigid frame and other frame side rail to provide a linear transfer vehicle that is rollingly supported on a single rail and such embodiment is described hereinafter with respect to FIGS. 24 to 28. The motor mount subassembly with a side rail secured thereto in this embodiment is referred to herein after as a vehicle and is designated 200. Referring to FIGS. 24 to 28 the vehicle 200 is rollingly supported by rollers on a single rail 300 that maybe the same as, or similar to, the rail 21 illustrated in FIG. 4 in the application as originally filed.

The rail 300 has amounting flange 301, a web 302 and a further flange 303. The flange 303 is spaced from the flange 301 and projects laterally from only one side of the rail. The rail has respective first and second opposite side faces. The flanges and web define an open faced channel 304 on the first side face of the rail and a series of magnet mounting plates 305 are mounted in end-to-end relation on the rail on the second side face. A plurality of magnets 306 are secured by suitable means in side-by-side relation on the plates 305 providing a strip of magnets that extend longitudinally along the second side face of the rail.

The vehicle 200 comprises a rigid frame having a channel 201 that receives therein a length portion of the rail that projects from its mounting flange 301. The rigid frame comprises respective first and second beams 202, 203 suitably joined together so as to act as a unitary member. The first beam 202 is a plate like member with a bulbous portion 204 extending along one marginal edge portion thereof. The second beam is a box like beam with flanges 205, 206. The bulbous part 204 of the first beam is connected to the box beam via the flanges thereon and by means of connector plates 208.

The vehicle is rollingly supported on and guided along the rail by respective first, second and third pluralities of rollers 210, 211 and 212. The first plurality of rollers 210 are journalled by axles 213 on the first beam 202 and these rollers are located in the channel 304 in the first side face of the rail. The second plurality of rollers 211 are arranged in pairs and engage the magnet mounting plates along parallel paths designated 215, 216 located respectively adjacent opposite marginal edges of the strip of magnets 306. A pair of rollers 211 are journalled by a common axle 217 on the beam 203 and there are two or more such pairs spaced apart from one another in a direction lengthwise of the track.

The third plurality of rollers 212 rollingly engage a surface portion 307 of the magnet mounting plates 305 on a portion 308 that projects beyond the rail.

A linear motor 220 is mounted on the box beam 203 and is located in the channel 201 in face-to-face relation with the magnets 306 on the second side face of the rail. Shims maybe used in mounting the motor and/or magnets to suitably position the same. The second plurality of rollers 211 define a selected minium air gap between the face of the magnets and the adjacently disposed face of the motor.

Movement of the platform is accomplished by interaction of the linear motors with the magnets based upon the Hall effect, whereby a transverse electric field is developed in a current-carrying conductor placed in a magnetic field. Ordinarily the conductor is positioned so that the magnetic field is perpendicular to the direction of current flow and the electric field is perpendicular to both. The high magnetic attraction between the coil assembly of the linear servo motors and magnet plates is very effective for preloading heavy-duty bearings commonly used in high force applications such as the closed loop servo performance required for the instant invention.

A trough shaped cover 250 is removably mounted on the box beam 203 and provides and accessible channel 251 for power cables and wiring of a control system for the motor.

Means are mounted to and/or in close proximity to at least one of the rails for generating pulses readable by a reader in communication with the control unit. The means comprises an optical or magnetic linear encoder system or other such device typically available from such manufacturers as Renishaw, RSF Electronics, Heidelhein and many others as a “commercial-off-the-shelf” item or other such custom-made units, consisting of a fixed glass scale or tape system with a precise series or pattern of graduated marks, bar codes, colors, shapes, scribes, holes, indentations, magnets or magnetic coding or other such indicators encoded on, mounted on or inscribed in the surface of the tape or scale at regular and/or repeating intervals of a known and fixed period. At least one electronic reader unit is mounted on the platform for reading and/or counting of the indicators encoded on the scale or tape system, as a means of establishing the position of the platform at any point along the length of rail system and controlling the movement of the platform by means of providing real-time feedback of the position or movement to the control unit.

For example in one preferred embodiment, a thin magnetic tape indicator strip extends along the inner surface of at least one of rail includes magnetized graduations which generate pulses readable by the a reader in communication with the control unit for the carrier as it moves along the rails.

It is contemplated that the means in close proximity to the rail for generating pulses readable by a reader in communication with the control unit can is replaced by or complimented with a “range-finding” device or interferometry system. A “range-finding” device or interferometry system can be used to accurately measure or determine distance to or from a fixed position. Typically the device comprises an electronic signal generator, receiver and interpretation device or other such electronic measurement hardware mounted on the moving platform and projecting a laser, infrared, ultrasonic, radar or other such signal onto a known “fixed” target consisting of fixed optics, reflective lens or other such material mounted fixed to a stationary position on the earth. It measures or calculates by means of signal processing or other electronic means a known or relative position of the platform based on the interpretation of the signal received from or reflected by the known fixed target. As the standard means of implementation, the interferometer device can be mounted on the moving platform with the fixed target mounted at one end of the rail system fixed to the earth, but the same results would be generated by the reverse-mounted orientation with a fixed interferometer and moving target and is anticipated as a required implementation for the invention. In either case, the interferometer system would function as a means of establishing the position of the platform at any point along the length of rail system and controlling the movement of the platform by means of providing real-time feedback of the position or movement of the platform to the control unit. Such interferometer or laser encoder systems are typically available from manufacturers such as Renishaw, Sick Optics and others as a “commercial-off-the-shelf” item or can be constructed by combining similar such available components to form a interferometry system of similar operation and function.

Applicant's prior patents describe the user of at least one fail safety brake is attached to the carrier having a brake shoe held in the “on” position by springs to bear against the inside one of more of the rails, wherein the brake shoe is spaced apart from the rail and held in the release “open” position by air pressure supplied to the actuators of the robot, so that failure of the air pressure permits the shoes to contact the guide rail 28 stopping the motion of the platform in case of an emergency.

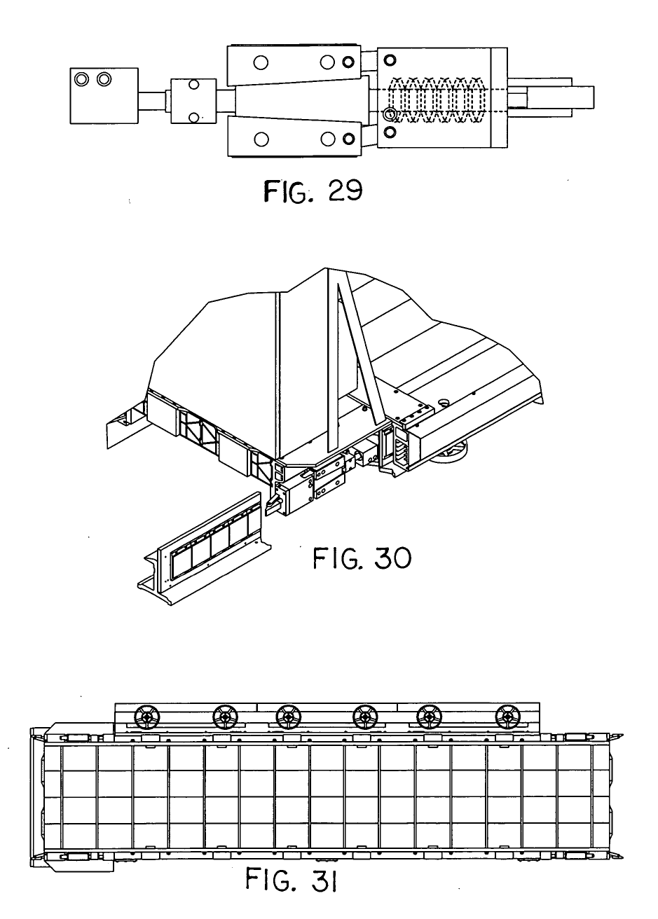

As depicted in FIGS. 29-31 of the present invention, a brake assembly is utilized with the carriage platform. As shown in FIG. 29 a high pressure nitrogen cylinder or hydraulic cylinder 500 is shown having a rod 502 extending therefrom into a trigger assembly 504 having a solenoid 506 disposed between a part of expanding brake shoes 508. The brakes are held together by springs and expand outward against the bottom and top flanges of the rail. The rod extends from the solenoid into a housing 510 containing a plurality of springs, preferably BELLEVILLE springs 512 which are cup shaped springs having the rod extend therethrough. The solenoid provides a trigger in that it is spring loaded and holds against the spring as long as electrical energy is supplied to it, upon losing power, the solenoid releases and the plunger trips the trigger which allows the springs 512 to exert pressure on the brake shoes 508 expanding them outward contacting the track to stop the carrier. Typically the shoes in the contracted position are spaced only a fraction of an inch from the rail flange surfaces. In one preferred embodiment about 1 to 2/32 of an inch.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

1. A rail carriage rollingly mountable on a track comprising a pair of spaced apart parallel rails, said carriage comprising a load carrying structural frame having rollers journalled thereon that rollingly engage and thereby support said carriage on said pair of rails, said frame having a pair of oppositely disposed marginal edges, a longitudinally extending motor mounting subassembly carried by said structural frame and providing a downwardly facing channel disposed to receive therein a portion of one of said pair of rails on which the carriage is rollingly supported, a linear motor mounted on said subassembly and located in said downwardly facing channel at a position in face-to face relation with a side face of said one rail and on which there is mounted thereon a strip of magnets

2. The rail carriage as defined in claim 1 wherein said load carrying structural frame comprises a plurality of elongate beams disposed in side-by-side relation and means interconnecting the same to provide a rigid load supporting structure.

3. The rail carriage as defined in claim 1 wherein said load carrying structural frame comprises one or more cast monolithic units.

4. The rail carriage as defined in claim 1 wherein said structural load carrying frame includes a pair of elongate frame side rails with one being located on one said marginal edges and the other on the other one of said marginal edges.

5. The rail carriage as defined in claim 4 wherein said load carrying rollers are journalled on respective ones of said frame side rails.

6. The rail carriage as defined in claim 5 wherein said frame side rails are detachably mounted on said carriage.

7. The rail carriage as defined in claim 1 wherein said subassembly has a portion thereof spaced from said carriage structural frame with the space therebetween providing said downwardly facing channel.

8. The rail carriage as defined in claim 7 wherein said downwardly projecting portion is a box-like beam.

9. The rail carriage as defined in claim 1 wherein said subassembly is detachably mounted on said carriage.

10. A track and carriage system comprising a pair of spaced apart parallel rails and a carriage rollingly mounted on said rails, said carriage comprising a load carrying structural frame having rollers journalled thereon rollingly engaging and thereby supporting said carriage on said pair of rails, said structural frame having a pair of oppositely disposed marginal edges, a longitudinally extending motor mounting subassembly carried by said structural frame and providing a downwardly facing channel receiving therein a portion of one of said pair of rails, a linear motor mounted on said subassembly and located in said downwardly facing channel at a position in face-to face relation with a side face of said one rail, a strip of magnets mounted on said rail side face and means maintaining a selected air gap between said linear motor and said strip of magnets.

11. Apparatus as defined in claim 10 wherein said carriage load carrying structural frame is a monolithic cast structure having a pair of frame side rails secured thereto and located on respective opposite parallel marginal edges thereof and wherein said load carrying rollers are journalled on said frame side rails

12. Apparatus as defined in claim 11 including a structural plate like member mounted on and overlying at east a portion of said load carrying structural frame.

13. Apparatus as defined in claim 10 wherein said strip of magnets is mounted on mounting strip secured to said one rail

14. Apparatus as defined in claim 13 including a plurality of rollers journalled on said subassembly and rolling engagable with said magnet mounting strip and thereby define a minium air gap between said linear motor and said strip of magnets.

15. Apparatus as defined in claim 1 wherein said frame side rails are extruded members.

16. Apparatus as defined in claim 2 wherein said elongate beams are extruded aluminum members.

17. The rail carriage as defined in claim 10 wherein said frame side rails and said elongate beams are extruded members.

18. Apparatus as defined in claim 10 wherein each of said rails include a vertically disposed web with a horizontally disposed flange on the lower end thereof, a strip of wear resistant material located on an upper surface of said flange and wherein the carriage supporting rollers run on said wear strips.

19. Apparatus as defined in claim 10 wherein each of said rails has a channel in a side thereof, wherein said rail channels are disposed in face to face relation and wherein said carriage supporting rollers are located in said channels.

20. A linear motor rail transfer vehicle comprising a rigid elongate rail having a mounting flange, a web and a further flange together providing a rail having respective first and second opposite side faces said flanges and web define an open faced channel along said first side face of the rail, an elongate magnet mounting strip of material secured to said rail and extending along said second side face and a carriage comprising a motor mounting subassembly movably mounted on said rail, said motor mounting subassembly including an elongate rigid beam having a open faced channel receiving therein a portion of said rail that projects from the surface of a support structure on which the rail is mounted, a first plurality of spaced apart rollers journalled on said rigid beam, said first plurality of roller be disposed in said open faced channel in said first side face of the rail, a second plurality of spaced apart rollers journalled on said carriage and rolling reacting against said second side face of the rail and a third plurality of rollers journalled on said carriage and rollingly reacting against said first side of the rail, said rollers rollingly supporting the carriage on the rail and guiding the same therealong, magnets secured to said magnet mounting strip and extending in a strip along said second side of the rail and a linear motor mounted on said beam and disposed in the channel therein in face-to-face relation with the magnets on said magnet mounting strip, said second plurality of rollers defining a selected minium air gap between the strip of magnets on the rail and an adjacently disposed face of the motor.

21. Apparatus as defined in claim 20 wherein said rigid magnet mounting strip has a portion thereof projecting beyond said rail in a direction toward a bottom wall of the channel in said carriage and wherein said projecting portion has a running surface for said second and third plurality of rollers disposed respectively on opposite sides of such strip.

22. Apparatus as defined in claim 21 wherein said magnet mounting strip is a plate like member having respective oppositely disposed first and second faces and wherein the second faces of said rail and strip are disposed in face-to-face relation.

23. Apparatus as defined in claim 22 wherein said second plurality of rollers are arranged in pairs with one roller of each pair rollingly engaging said first face of the magnet mounting strip in a path extending along a first marginal edge of the magnets and the other roller of each pair in a path extending along a second marginal edge of the magnets

24. Apparatus as defined in claim 20 wherein said elongate beam comprises first and second elongate members disposed side-by-side and means interconnecting, said channel in said subassembly having opposed side walls defined respectively by said first and second elongate members.

25. Apparatus as defined in claim 24 wherein said first elongate member comprises an elongate box bean and said second elongate member comprises an elongate flat bar with a bulbous portion extending along one marginal edge thereof, said first plurality of rollers being journalled for rotation bu suitable axle means on said flat bar portion and means connection said bulbous portion to said box beam.

26. Apparatus as defined in claim 25 wherein said bulbous portion is connected to said box beam via flanges on said box beam.

27. Apparatus as defined in claim 24 wherein said first and second elongate members are extruded members.
